(19) United States
(12) Patent Application Publication
(10) Pub. No.: US 2025/0150190 A1
(43) Pub. Date: May 8, 2025

(54) Dynamic Provisioning of Precision Time Protocol (PTP) Enabled Ports in Multiclock Architecture

(71) Applicant: Altera Corporation, San Jose, CA (US)

(72) Inventors: Krishna Kumar Simmadhari Ramadass, Bangalore (IN); Preetam Narayan, Berhampur (IN)

(21) Appl. No.: 18/990,998

(22) Filed: Dec. 20, 2024

(51) Int. Cl. H04J 3/06

(52) U.S. Cl. CPC H04J 3/0667

(57) ABSTRACT

Integrated circuit devices, methods, and circuitry for a timestamp engine to dynamically provision ports in accordance with PTP synchronization are provided. An integrated circuit device may include a number of ports configurable to communicate using timestamps corresponding to a number of Precision Time Protocol (PTP) clock domains. The integrated circuit may further include a timestamp engine configurable to receive timestamp requests and route a time of day (ToD) from a ToD circuit of a plurality of ToD circuits to different ports of the plurality of ports, where each ToD circuit is based on a PTP clock domain of the plurality of PTP clock domains.

### BACKGROUND

The present disclosure relates generally to packet transmission in accordance with Precision Time Protocol (PTP). More particularly, the present disclosure relates to a timestamp engine for facilitating packet transmission over a network switch in accordance with PTP.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

PTP is a protocol for clock synchronization throughout computer networks. Clock synchronization is useful in distributed systems for tasks such as synchronous data acquisition or simultaneous event triggering, among many other data transfer processes. In a PTP-enabled architecture, a TimeTransmitter (formerly referred to as a master) is aligned with one or more associated TimeReceivers (formerly referred to as slaves and sometimes also referred to as subordinates). The TimeTransmitter performs hardware time stamping on packets with a time of day (ToD). The ToD is maintained in a register of the transmitter and refers to the time a packet was transmitted or received and may record time in precise increments (e.g., nanoseconds). There are many different possible PTP clock domains that may be used by different entities. For example, different entities may use a clock domain that is based on a different underlying clock (e.g., coordinated universal time, global positioning system (GPS) time, international atomic time) and each PTP clock domain may slightly vary. That is, two different TimeTransmitters aligned with different PTP clocks may timestamp packets at the exact same time and the resulting ToDs imparted onto those packets will differ. Because PTP enabled architecture specifies that the TimeTransmitter and TimeReceiver be synchronized, even very small fluctuations in ToD can lead to difficulties.

### BRIEF DESCRIPTION OF THE DRAWINGS

Various aspects of this disclosure may be better understood upon reading the following detailed description and upon reference to the drawings in which:

FIG. 1 is a diagram of a shared hardware environment, including TimeTransmitters and TimeReceivers, in accordance with aspects of the present disclosure;

FIG. 2 is a diagram of a network switch including a timestamp engine, in accordance with aspects of the present disclosure;

FIG. 3 is a diagram of the components that may be included in a timestamp engine, in accordance with aspects of the present disclosure;

FIG. 4 is a flowchart of a method for provisioning a downstream port to a Master ToD register across a timestamp engine, in accordance with aspects of the present disclosure;

FIG. 5 is a flowchart of a method for adding a new Master ToD register to the timestamp engine, in accordance with aspects of the present disclosure;

FIG. 6 is a diagram of a timestamp engine with hardware components to support Synchronous Ethernet (SyncE) protocol, in accordance with aspects of the present disclosure;

FIG. 7 is a flowchart of a method for enabling Synchronous Ethernet (SyncE) protocol on a network switch that includes a timestamp engine, in accordance with aspects of the present disclosure; and

FIG. 8 is a block diagram of a data processing system that may incorporate the timestamp engine, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

In a shared hardware environment, many downstream ports may be accessible to a number of different TimeTransmitters associated with different PTP clock domains. Because synchronization is specified under Precision Time Protocol for data transfer, according to previous designs, the ports in the shared hardware environment may be reserved for a specific TimeTransmitter with a known PTP clock. Yet binding a downstream port to a single TimeTransmitter is inefficient (e.g., ports may be inaccessible to other TimeTransmitters) and can cause transmission backups. The disclosed systems and methods for handling multiple TimeTransmitters in a shared hardware environment provide an improvement.

A timestamp engine may be used as an intermediary between many TimeTransmitters and TimeReceivers. Specifically, the timestamp engine may be useful for connecting and facilitating the transmission of ToD information from a TimeTransmitter to an available downstream port (e.g., a PTP enabled Ethernet port). Rather than the downstream ports being reserved for a particular TimeTransmitter that communicates according to a specified PTP clock domain, the timestamp engine allows the TimeTransmitter to communicate with any of the available downstream ports. In one embodiment, a network switch receives a PTP packet from a TimeTransmitter. A programmable logic device on the network switch contains a host data processing system that conditions a Master ToD circuit associated with the TimeTransmitter. The Master ToD circuit may be implemented according to hard logic or software executed by a processor and holds ToDs according to the PTP clock domain of the TimeTransmitter. The timestamp engine bridges a selected downstream port to the Master ToD circuit. As packets are transmitted from and received by the network switch, the timestamp engine routes timestamp read/write requests from the selected downstream port to the appropriate Master ToD circuit.

In some embodiments, TimeTransmitters may be added to or removed from the network switch. That is, an additional TimeTransmitter may desire to use the network switch, or an existing TimeTransmitter may no longer operate over the network switch. The programmable logic device may be partially reconfigured to define Master ToD circuitry when this occurs. For example, in the case of a new TimeTransmitter communicating over the network switch, the programmable logic device may be reconfigured to define an additional Master ToD circuit. Partially reconfiguring the programmable logic device to define or remove Master ToD circuits does not affect the functioning of the other Master ToD circuits or other ethernet ports or any other functionality on the programmable logic device. That is, other Master ToD circuits providing ToDs or the downstream ports may not need to be reset and will not otherwise be affected (e.g., transmission blackouts) when the programmable logic device is partially reconfigured.

The timestamp engine, conversely, does not have to apply partial reconfiguration when bridging TimeTransmitters to new or additional ports. That is, software implementations may allow TimeTransmitters to begin communicating with additional downstream ports or terminate existing connections with downstream ports. The network switch may improve the handling of the bandwidth (e.g., may optimize the bandwidth) of each TimeTransmitter that it receives PTP packets from. In this way, the downstream ports may be provisioned to the demands of the TimeTransmitters communicating over the network switch.

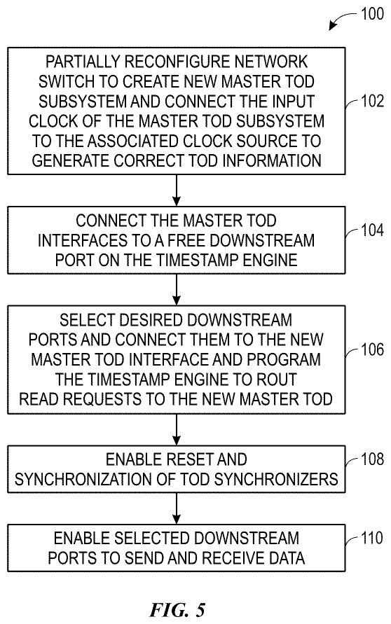

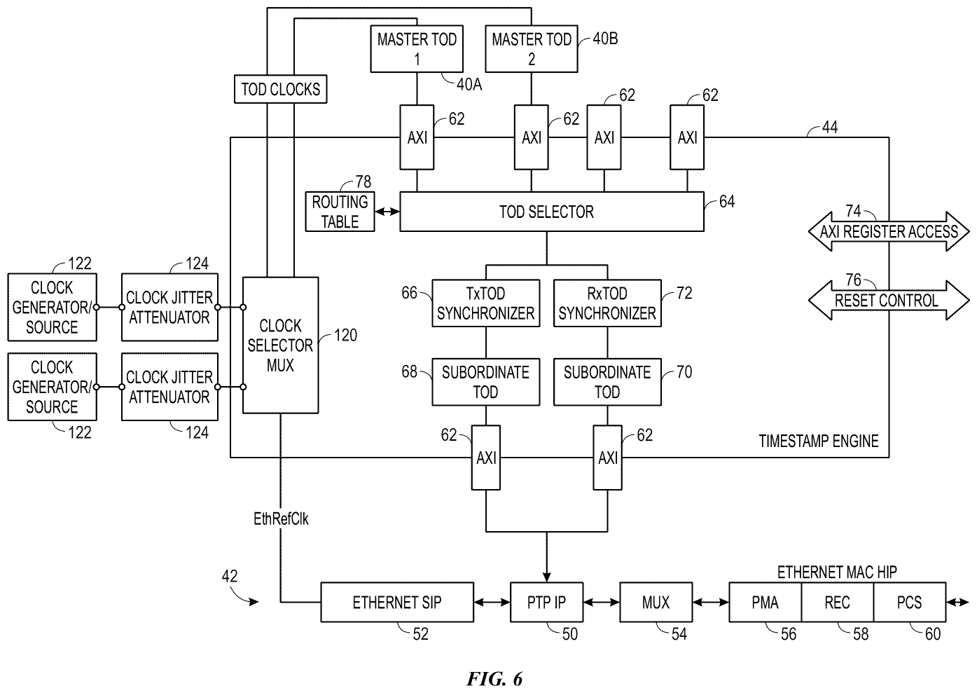

As discussed in more detail with reference to FIGS. 5 and 6, methods and protocols for responding to write and read requests of the downstream ports with synchronized ToDs are disclosed herein. Likewise, methods and protocols for adding Master ToD circuitry to promote PTP synchronized communication for new TimeTransmitters accessing the network switch are also disclosed.

In some embodiments, the timestamp engine may support SyncE communication. To enable SyncE packet transmission, the reference clock of the TimeTransmitter may be provided to the timestamp engine. The timestamp engine may use the reference clock of the TimeTransmitter to transmit frequency and/or phase information to the Master ToD circuitry associated with the TimeTransmitter and the downstream port that the TimeTransmitter is communicating with.

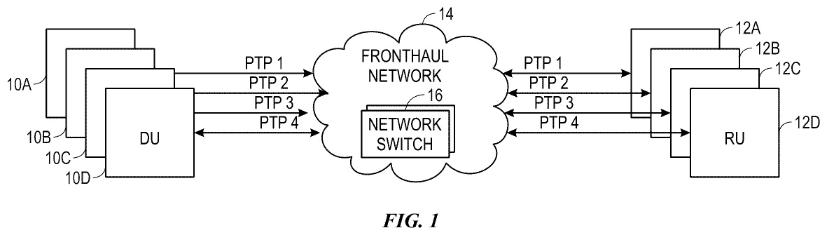

By way of introduction, FIG. 1 provides an example of a shared hardware environment with multiple PTP clock domains. In an open radio access network (O-RAN) LLS-C2configuration, O-RAN Distributed Units (O-DUs) 10A, 10B, 10C, 10D are connected over a network 14 (e.g., a fronthaul network) to one or more O-RAN Radio Units (O-RUs) 12A, 12B, 12C, 12D. The O-DUs 10A, 10B, 10C, 10D prepare data for transmission. Thus, the O-DUs 10A, 10B, 10C, 10D act as TimeTransmitters providing synchronization with downstream devices via Precision Time Protocol (PTP) packets. Conversely, the O-RUs 12A, 12B, 12C, 12D are radio access nodes interfacing between customer devices (e.g., mobile phones) and the network 14. In PTP enabled architecture, the O-RUs 12A, 12B, 12C, 12D may act as TimeReceivers. In this example, the network 14 is a fronthaul network enabling the O-DUs 10A, 10B, 10C, 10D to transmit data to the O-RUs 12A, 12B, 12C, 12D. The network 14 includes any suitable number of network switches 16 to route the packets transmitted from an O-DU 10A, 10B, 10C, 10D to a desired O-RU 12A, 12B, 12C, 12D.

The O-DUs and O-RUs may belong to different customers and, therefore, use different underlying clocks (e.g., different PTP clock domains). By way of example, this could happen in a telecommunications environment when many customers (e.g., cellular service providers) transmit data over shared hardware like a cell tower. In this example of a shared hardware environment, O-DUs 10A, 10B, 10C, 10D belonging to different customers may use the same network 14. The network switch 16 routes packets received from the O-DUs 10A, 10B, 10C, 10D to the available downstream ports, and resultingly to the O-RUs 12A, 12B, 12C, 12D. In this way, different customers can communicate with client devices across any available downstream port 42 on the network switch 16 that is maintained in the shared hardware.

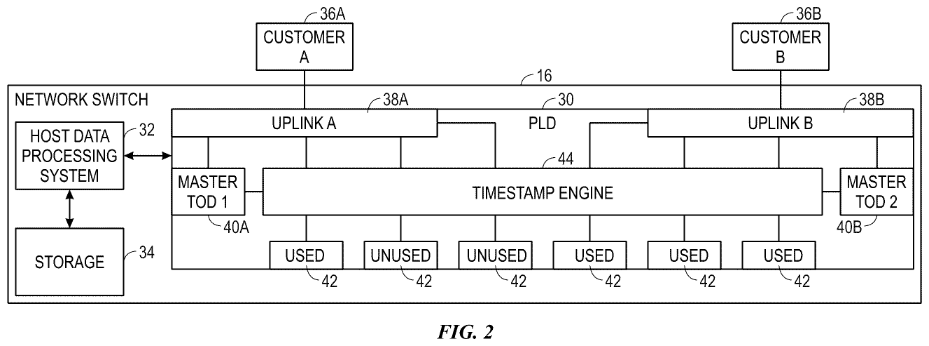

FIG. 2 provides an example of one network switch 16. The network switch 16 may include a programmable logic device 30 for facilitating the transmission of ToDs from one or more TimeTransmitters to one or more downstream ports 42. The programmable logic device 30 may be any device that permits digital circuitry reconfiguration (e.g., a field programmable gate array (FPGA)). The network switch 16 may also include a host data processing system 32 and storage 34. The host data processing includes software or hardware logic (e.g., PTP Servos) to read timestamps from PTP packets that the TimeTransmitters transmit to the network switch 16 at the uplink port 38 and condition the Master ToD circuitry associated with each TimeTransmitter accordingly. For example, Customer A 36A and Customer B 36B may transmit packets into the network switch 16 and may operate in different clock domains. Customer A 36A may act as a TimeTransmitter providing PTP packets associated with a first PTP clock domain, whereas Customer B 36B may act as a TimeTransmitter providing PTP packets associated with a second PTP clock domain. Looking back to FIG. 1, Customer A 36A may control one or more of the O-DUs (e.g., O-DUs 10A, 10B). Similarly, Customer B 36B may control another O-DU (e.g., O-DU 10C). Each customer 36A, 36B may have a dedicated uplink 38. The uplink 38 is a port (e.g., an Ethernet port) that enables the programmable logic device 30 to receive ToD information from PTP messages.

As depicted in FIG. 2, Customer A 36A is connected to Uplink A 38A and Customer B 36B is connected to Uplink B 38B. The network switch 16 receives the PTP packets from each Customer 36A, 36 B at their respective uplink 38A, 38B. The host data processing system 32 extracts the ToD information from the received PTP packets and conditions the appropriate Master ToD circuit 40A, 40B. Because Customer A 36A and Customer B 36B may use different PTP clock domains, each uplink 38A, 38B is connected to the Master ToD circuit 40A, 40B of the respective customers 36A, 36B. Due to inherent delays in wireless transmission (e.g., delays caused by network interference) the ToD received by the network switch 16 may be slightly offset from the ToD provided by the source clock of the customers 36A, 36B. Thus, the Master ToD circuits are conditioned to the ToD determined by the host data processing system 32.

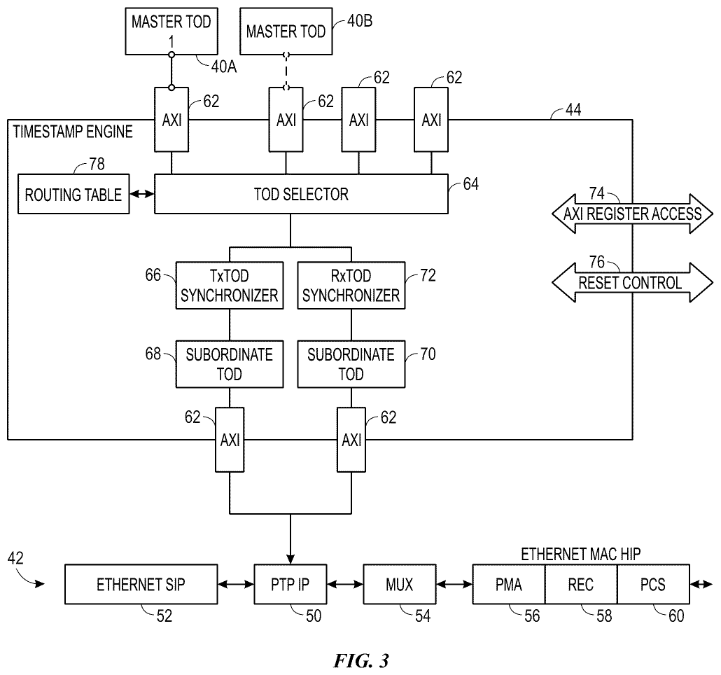

In this example, the ToDs of the PTP packets transmitted by Customer A 36A condition Master ToD circuit 40A and the ToDs of the PTP packets transmitted by Customer B 36B condition Master ToD circuit 40B ToD. It should be noted that the PTP packets may not be routed to the downstream ports 42 across the timestamp engine 44. Rather, the ToDs that are used to maintain PTP synchronization are routed across the timestamp engine 44. The ToDs may be routed according to a programmable routing table (78 in FIG. 3) on the timestamp engine 44.

Continuing with FIG. 2, each downstream port 42 is connected to the timestamp engine 44. Rather than permanently dedicate the downstream ports 42 to a Master ToD circuit 40 for a specified customer 36, the timestamp engine 44 permits dynamic provisioning of downstream ports 42 to any customer 36 communicating across the network switch 16 while maintaining PTP synchronization.

FIG. 3 provides an example of the timestamp engine 44. The Master ToD circuits 40A, 40B are connected to the timestamp engine 44 through any suitable interfaces, such as Advanced extensible Interface (AXI) interfaces 62. In some embodiments, the AXI interfaces 62 may be programmed to connect to new Master ToD circuitry 40B. For example, when additional TimeTransmitters (e.g., customers) access the network switch 16, the programmable logic device 30 may be partially reconfigured to define Master ToD circuitry 40B for the additional TimeTransmitter; the defined Master ToD circuitry 40B may be connected to a designated AXI interface 62. The downstream ports 42 are also connected to the timestamp engine 44 by AXI interfaces 62. The timestamp engine 44 promotes PTP synchronization such that the downstream ports 42 may be PTP enabled Ethernet ports.

The downstream ports 42 may include various components to enable packet transmission and reception. For example, the downstream ports 42 may contain PTP extraction circuitry 50 (sometimes referred to as PTP IP or PTP intellectual property). The PTP extraction circuity 50 receives the ToD information from the timestamp engine 44 and completes packet timestamping. That is, when the downstream ports transmit or receive packets, the PTP extraction circuitry 50 may receive the ToD from the Master ToD circuit 40 for the associated TimeTransmitter and complete packet timestamping.

The downstream ports 42 may also include soft logic circuitry 52. The soft logic circuitry 52 defines how the port transmits and receives packets. That is, the timestamp engine 44 is predominantly designed to synchronize transmitted and received PTP packets to a ToD associated with the Master ToD circuitry 40 on the network switch 16. The soft logic circuitry 52 refers to the software implementation of Ethernet protocols. In other words, the soft logic circuitry 52 refers to the software protocol for transmitting and receiving PTP packets. The downstream ports 42 may also contain a multiplexer 54 for signal handling. The downstream ports 42 may use a physical medium attachment (PMA) 56 to transmit serialized parallel data and deserialize received data. The downstream ports 42 may include a forward error correction (FEC) component 58 for error correcting in packet transmission. The downstream ports 42 may also contain a physical coding sublayer (PCS) 60 for packet mapping to the PMA interface 56.

Returning to the timestamp engine 44, the upstream AXI interfaces 62 communicatively connect a ToD selector 64 to the Master ToD circuits 40. The ToD selector 64 is connected to a routing table 78. The routing table 78 maintains the connections (e.g., routing paths) between the TimeTransmitters (e.g., customers 36A, 36B) and the downstream ports 42. The routing table 78 allows the timestamp engine 44 to route timestamp read requests from a selected downstream port 42 to the designated Master ToD circuit 40 that is communicating with the selected downstream port 42. For example, if one of the downstream ports 42 is communicatively connected to Customer B 36B, that downstream port 42 may generate a read request for a timestamp, and the ToD selector 64 routes the read request to the appropriate Master ToD circuitry 40B. As mentioned above, the routing table 78 is connected to the ToD selector 64. The ToD selector 64 may identify the communication pathways (e.g., the connections) between the Master ToD circuits 40 and downstream ports 42. When a read or write request is generated by a selected downstream port, the ToD selector 64 routes the ToD from the appropriate Master ToD circuit 40 to the downstream port 42 requesting the ToD. In other embodiments, the ToD selector 64 can route ToD streams to the selected downstream port 42. That is, it may be desirable to continuously stream ToDs to the PTP extraction circuitry 50 of the selected downstream port 42.

In some embodiments, synchronizers 66, 72 may be used to enable the streaming of ToDs from the Master ToD circuits 40 to the downstream ports 42. A transmitting ToD synchronizer (TxToD) 66 bridges the Master ToD circuity 40 to a transmitter module (TX module) of the selected downstream port 42. The TxToD synchronizer 66 is used because the programmable logic device 30 may be operating according to a different clock than the Master ToD circuitry. The TxToD synchronizer 66 synchronizes the ToD provided by the Master ToD circuit 40 to the clock domain of the programmable logic device 30 to determine a subordinate ToD 68. The subordinate ToD 68 is provided (e.g., via the connected AXI interface 62) to the PTP extraction circuitry 50 of the selected downstream port 42. This process enables a PTP packet to be transmitted to be timestamped. Likewise, when the downstream port 42 receives a PTP packet, it may timestamp the packet according to the designated Master ToD circuit 40 on the network switch 16. Thus, the timestamp engine 44 includes a receiving ToD synchronizer (RxToD) 72. The RxToD synchronizer 72 synchronizes the ToD provided by the Master ToD circuit 40 to the clock domain of the programmable logic device 30 to determine a subordinate ToD 70. This allows the PTP extraction circuity 50 of the downstream port 42 to complete timestamping of a received PTP packet.

In some embodiments, the timestamp engine 44 may be connected to additional Master ToD circuits 40. For example, if the programmable logic device 30 is partially reconfigured to accommodate a new TimeTransmitter (e.g., a new customer 36), a new Master ToD circuit 40 may be defined in the hard logic of the programmable logic device 30. As described above, the Master ToD circuits 40 provide ToDs to the timestamp engine 44 via AXI interfaces 62. To accommodate new Master ToD circuits 40, the timestamp engine 44 includes AXI register access 74 and reset controls 76.

The ToD selector 64, the routing table 78, and the synchronizer modules 66, 72 allow a TimeTransmitter (e.g., Customer A 36A in FIG. 2) seeking to expand its bandwidth to connect to any of the available downstream ports 42 without having to partially reconfigure or reset the programable logic device 30. That is, a service provider may update the routing table 78 to define connections between the Master ToD circuits 40 and downstream ports 42. In other embodiments, as the TimeTransmitters bandwidth needs change, the host data processing system 32 may redefine the routing table to assign downstream ports to certain TimeTransmitters. Connections between any of the downstream ports 42 and the Master ToD circuits 40 may be terminated or unassigned in the same way without reconfiguring the programable logic device 30.

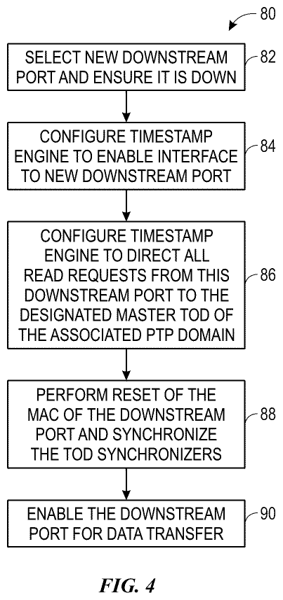

FIG. 4 provides a flowchart 80 of protocol for provisioning a downstream port 42 to a Master ToD circuit 40. Starting at block 82, the timestamp engine 44 selects a downstream port 42 and ensures that it is available for communication. A downstream port 42 may be unavailable for communication, for example, if it is actively communicating with a Master ToD circuit 40. In some embodiments, the service provider may determine that the downstream port 42 is available. Once a downstream port is identified as available, it is selected and may be disabled by the host data processing system 32. Disabling the downstream port 42 may prevent packet transmission errors by ensuring that the downstream port 42 is not actively transmitting or receiving PTP packets while being communicatively synchronized to a Master ToD circuit 40.

At block 84, an AXI connection between the selected downstream port 42 and the timestamp engine is enabled.

At block 86, the timestamp engine directs all read requests from the downstream port 42 to the designated Master ToD circuit 40. For example, the routing table 78 may be updated (e.g., by the host data processing system 32 or the service provider) to indicate that a first downstream port 42 is now connected to a first Master ToD circuit 40.

Moving to block 88, the medium access control (MAC) of the selected downstream port 42 is reset. The TxToD and RxToD synchronizers 66 and 72 may also be synchronized to the Master ToD circuit 40. The TxToD and RxToD synchronizers 66, 72 are useful because the programmable logic device 30 may operate according to a different clock domain than the Master ToD circuits 40 provide.

At block 90, the downstream port 42 is enabled by the host data processing system 32 and may begin communicating (e.g., transmitting and receiving PTP packets). At this stage, if the downstream port 42 generates a read or write request, it will be routed to the proper Master ToD circuit via the timestamp engine 44. The Master ToD circuit may provide the ToD to the downstream port 42, and the PTP extraction circuitry 50 of the downstream port 42 may complete timestamping of the PTP packets.

FIG. 5 offers another flow chart 100 depicting a process of adding a new Master ToD circuit 40B to the timestamp engine 44. This process is useful when a new TimeTransmitter (e.g., a new customer 36) seeks to engage in PTP-supported packet transmission across the network switch 16. Returning to the previous example, this could happen in a telecommunications network when a new service provider desires to use a fronthaul network 14, and therefore a network switch 16, to transmit data over a cell tower that it had not previously used.

Starting at block 102, the programmable logic device 30 on the network switch 16 is partially reconfigured to enable a new TimeTransmitter to transmit and receive packets. The programmable logic device 30 is partially reconfigured to define a new Master ToD circuit 40B and uplink 38 B associated with the new TimeTransmitter. The new TimeTransmitter transmits PTP packets to the designated uplink 38. The host data processing system 32 conditions the new Master ToD circuit 40 to the ToD that it extracts from the PTP packets received at the uplink 38B from the new TimeTransmitter. Note that the timestamp engine 44 need not be partially reconfigured. Rather, the new Master ToD circuitry 40B is connected to the timestamp engine via AXI interfaces 62, which may provide a software implementable connection performed by the service provider.

At block 104, the new Master ToD circuit 40B is connected to one or more available downstream ports 42. The available downstream ports 42 may be selected according to the protocol discussed with respect to blocks 82 and 84 in FIG. 4.

Returning to FIG. 5 and moving to block 106, the one or more selected downstream ports 42 are connected to the new Master ToD circuit 40B. The routing table 78 on the timestamp engine 44 is reprogrammed (e.g., by adding a new entry or overwriting an existing entry) to define a connection between the new Master ToD circuit 40B and the one or more selected downstream ports 42. Updating the routing table 78 enables the ToD selector 64 to properly route read/write requests from the PTP extraction circuitry 50 of the one or more selected downstream ports 42 to the new Master ToD circuit 40B.

At block 108, the TxToD synchronizer 66 and RxToD synchronizer 72 modules that bridge the new Master ToD circuit 40B to the one or more selected downstream ports 42 are reset and synchronized to the ToDs provided by the new Master ToD circuit 40B. At this stage, the synchronizer modules 66, 72 can now generate subordinate ToDs 68, 70, and transmit the ToDs to the PTP extraction circuitry 50 of the one or more selected downstream ports 42.

At block 110, the new Master ToD circuit 40B communicates with the selected downstream port 42 in accordance with PTP synchronization protocol. For example, the new Master ToD circuit 40B may receive read and write requests from the PTP extraction circuitry 50 of the selected downstream port 42. In response, the new Master ToD circuitry 40B may provide ToDs to the timestamp engine 44 to be routed to the selected downstream port 42. Likewise, in some embodiments, the new Master ToD circuit 40B may continuously stream ToDs to the PTP extraction circuitry 50 of the selected downstream port 42.

FIG. 6 provides a diagram of another embodiment of the timestamp engine 44. In this diagram, the components of the timestamp engine 44 are maintained as described in FIG. 3. However, additional components are included to support Synchronous Ethernet (SyncE). SyncE is a protocol specifying upstream and downstream phase and frequency synchronization. That is, in SyncE enabled communication, the frequency of the Master ToD circuit 40 and downstream ports 42 is synchronized to the frequency of the TimeTransmitter (e.g., the frequency at which the TimeTransmitter's system works). In other words, SyncE specifies that TimeTransmitters and TimeReceivers communicate over a similar frequency domain. Because SyncE runs in the Ethernet domain, the uplinks 38 and downstream ports 42 are hereinafter referred to as uplink Ethernet ports 38 and downstream Ethernet ports 42.

To enable SyncE, the clock of the TimeTransmitter is recovered from the uplink Ethernet port 38. The recovered clock is synchronized to the frequency and phase of the of the TimeTransmitter. The recovered clock is provided to the downstream Ethernet ports 42 and to the Master ToD circuit 40 associated with the TimeTransmitter. That is, the recovered clock may be used as the clock generator/source 122 for the Master ToD circuit 40 and selected downstream Ethernet port 42. The Ethernet subsystem that is defined by these components may, therefore, run synchronously with the Time Transmitter.

SyncE may be supported by including a clock selector multiplexer 120 on the timestamp engine 44. The clock selector multiplexer 120 selects a clock generator/source 122 and clock jitter attenuator 124 corresponding to a particular Master ToD circuit (e.g., the Master ToD circuit 40A). The clock selector multiplexer 120 may select the clock generator/source 122 according to a service provider implementation. For example, a first clock generator/source 122 may be conditioned by a first uplink 38. That is, the recovered clock of the uplink Ethernet port 38A is fed to the first clock generator/source 122 associated with a first TimeTransmitter and the recovered clock of the uplink Ethernet port 38B is fed to a second clock generator/source 122 associated with a second TimeTransmitter. The clock generator/source 122 is synchronized to the corresponding TimeTransmitter. In this way, the clock generator/source 122 may act as a clock that is sufficiently synchronized to the designated uplink Ethernet port 38. For example, the clock generator/source 122 may be synchronized to a recovered clock of the TimeTransmitter from its associated uplink Ethernet port 38. In some embodiments, the clock generator/source 122 may be connected (e.g., programmed) and synchronized to other uplink Ethernet ports 38. The clock jitter attenuator 124 accounts for high frequency jitter that occurs as a byproduct of these changes.

Because the disclosed timestamp engine 44 permits dynamic provisioning of the downstream ports 42 to different Master ToD circuits 40, in some embodiments, the programmable logic device 30 may be further digitally reconfigured to define additional clock generators/sources 122 and clock jitter attenuators 124. Although FIG. 6 displays just two clock generators/sources 122, it should be noted that, in other examples, the programmable logic device 30 may be partially configured to include more clock generators/sources 122 to promote SyncE for each TimeTransmitter on the network switch 16. In some embodiments, for example, the number of clock source/generators 122 may match the number of supported uplink ports 38. For example, if there are three Master ToD circuits 40 (e.g., because three TimeTransmitters use the network switch 16) the programmable logic device 30 may be partially reconfigured to include three clock generators/sources 122 and three clock jitter attenuators 124.

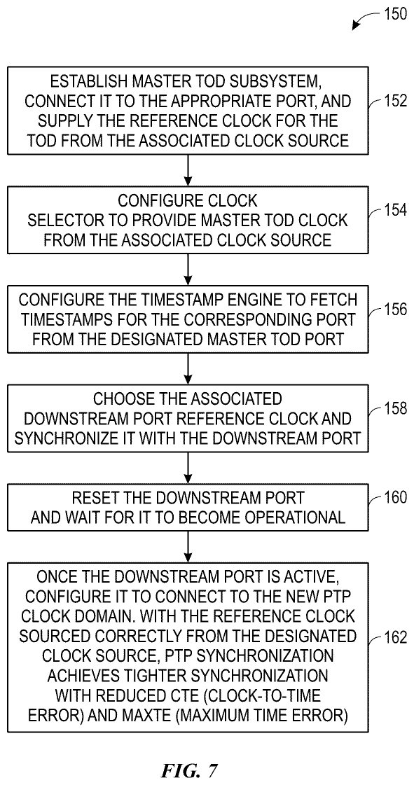

FIG. 7 is a flowchart 150 depicting a process for enabling SyncE protocol with the timestamp engine 44. At block 152, as discussed with reference to FIGS. 4 and 5, a Master ToD subsystem is established. That is, as a new TimeTransmitter begins communicating over the network switch 16, the programmable logic device 30 may be partially reconfigured to define a new uplink Ethernet port 38 and new Master ToD circuit 40. The Master ToD circuit 40 is connected to the timestamp engine 44 to enable ToDs to be sent to a selected downstream Ethernet port 42. The frequency of the reference clock (e.g., clock source 122) of the TimeTransmitter is supplied to the Master ToD circuit 40 and the soft logic circuitry 52 of the selected downstream Ethernet port 42. This connection is facilitated by programming the clock selector multiplexer module 120 on the timestamp engine 44.

The clock selector multiplexer 120 provides a benefit because a path defined by the timestamp engine 44 may be updated or otherwise change. That is, as discussed throughout this disclosure, the Master ToD circuits 40 may communicate with different downstream ports 42 depending on the needs of their associated TimeTransmitters. For example, the routing table 78 may be updated by the service provider to accommodate the needs of many Time Transmitters on the network switch 16. By including the clock selector multiplexer 120 on the timestamp engine 44, the frequency of the clock generator/source 120 may be provided to the appropriate Master ToD circuit 40 and the soft logic circuitry 52 of the communicatively connected downstream port 42.

Moving to block 154, the clock selector multiplexer 120 routes (e.g., via a software implementation, such as a clock frequency routing table) the frequency information from the clock generator/source 122 to the designated Master ToD circuit 40 and the soft program logic 52 of the selected downstream port 42.

At block 156, the timestamp engine 44 is configured to connect the Master ToD circuit 40 to the corresponding uplink Ethernet port 38 and downstream Ethernet ports 42. To facilitate this connection, the routing table 78 may be updated to reflect these connections.

At block 158, the reference clock of the selected downstream Ethernet port is synchronized with the associated clock source (e.g., clock generator/source 122). That is, the clock selector multiplexer 120 routes frequency and phase information of the clock generator/source 122 to the reference clock of the selected downstream Ethernet port 42.

Turning to block 160, the selected downstream Ethernet port 42 is reset. At this point, there may be an operational delay while the reset is performed. Once the reset is complete, the downstream Ethernet port 42 may be enabled (e.g., by the host data processing system 32) to receive ToDs from the Master ToD circuit 40 at the PTP extraction circuitry 50. Likewise, the downstream Ethernet port 42 may receive frequency from the clock selector multiplexer 120 at the soft programmable logic 52.

At block 162, after the selected downstream Ethernet port 42 is operational, it is synchronized to the PTP clock domain of the TimeTransmitter. The selected Ethernet downstream port 42 receives frequency and phase information from the reference clock source 122 on the programmable logic device 30. The selected downstream Ethernet port 42 receives ToDs from the associated Master ToD circuit 40 by way of the timestamp engine 44. Because the timestamp engine 44 includes the clock selector multiplexer 120, it can transmit the frequency and phase information to the selected downstream Ethernet port 42. Moreover, as the downstream Ethernet ports 42 are reassigned (e.g., assigned to new TimeTransmitters) the timestamp engine 44 uses the clock selector multiplexer 120 to provision the frequency and phase information from the clock generator/source 122 of the appropriate TimeTransmitter to the selected downstream port 42. Therefore, the reference clock for the selected downstream Ethernet port 42 may be synchronized to the reference clock associated with the TimeTransmitter that it communicates with.

The method described with respect to FIG. 7 promotes SyncE communication among other benefits. For example, providing the reference clock of the selected downstream Ethernet port 42 with frequency and phase information from the clock generator/source 122 may result in reduced clock-to-time error (cTE) and maximum time error (maxTE) between the TimeTransmitter and downstream Ethernet port 42. Reduced cTE and maxTE are indicative of a tighter synchronization between the timestamp that the network switch 16 receives from a TimeTransmitter and the timestamp information that the selected downstream Ethernet port 42 imparts onto a PTP packet.

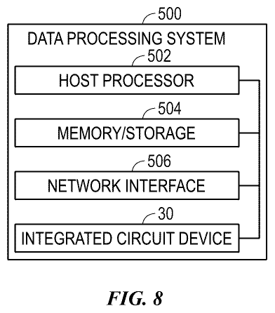

The circuit discussed above may be implemented on the programmable logic device 30, which may be an integrated circuit device component included in a data processing system, such as a data processing system 500, shown in FIG. 8. The data processing system 500 may include the integrated circuit system 30 (e.g., a programmable logic device), a host processor 502, memory and/or storage circuitry 504, and a network interface 506. The data processing system 500 may include more or fewer components (e.g., electronic display, user interface structures, application specific integrated circuits (ASICs)). Moreover, any of the circuit components depicted in FIG. 8 may include the integrated circuit system 30 with the timestamp engine 44. The host processor 502 may include any of the foregoing processors that may manage a data processing request for the data processing system 500 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 504 may include random access memory (RAM), read-only memory (ROM), one or more hard drives, flash memory, or the like. The memory and/or storage circuitry 504 may hold data to be processed by the data processing system 500. In some cases, the memory and/or storage circuitry 504 may also store configuration programs (e.g., bitstreams, mapping function) for programming the integrated circuit system 30. The network interface 506 may allow the data processing system 500 to communicate with other electronic devices. The data processing system 500 may include several different packages or may be contained within a single package on a single package substrate. For example, components of the data processing system 500 may be located on several different packages at one location (e.g., a data center) or multiple locations. For instance, components of the data processing system 500 may be located in separate geographic locations or areas, such as cities, states, or countries.

The data processing system 500 may be part of a data center that processes a variety of different requests. For instance, the data processing system 500 may receive a data processing request via the network interface 506 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. For example, the timestamp engine 44 described herein may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

### Example Embodiments

EXAMPLE EMBODIMENT 1. An integrated circuit device comprising:
a plurality of ports configurable to communicate using timestamps corresponding to a plurality of Precision Time Protocol (PTP) clock domains; and
a timestamp engine configurable to receive timestamp requests and route a time of day (ToD) from a ToD circuit of a plurality of ToD circuits to different ports of the plurality of ports, wherein each ToD circuit is based on a PTP clock domain of the plurality of PTP clock domains.

EXAMPLE EMBODIMENT 2. The integrated circuit device of example embodiment 1, wherein the plurality of ports comprises a plurality of Ethernet ports.

EXAMPLE EMBODIMENT 3. The integrated circuit device of example embodiment 1, wherein the timestamp engine comprises a ToD selector configurable to select from among the different ToD circuits associated with the plurality of PTP clock domains.

EXAMPLE EMBODIMENT 4. The integrated circuit device of example embodiment 3, wherein the ToD selector is configurable to select a first ToD circuit from among the different ToD circuits to provide a ToD to a downstream port of the plurality of ports, wherein the different ToDs circuits are accessible via an industry-defined interface.

EXAMPLE EMBODIMENT 5. The integrated circuit device of example embodiment 4, wherein the industry-defined interface comprises an Advanced extensible Interface (AXI) interface.

EXAMPLE EMBODIMENT 6. The integrated circuit device of example embodiment 1, wherein the timestamp engine comprises a first path corresponding to providing ToDs for a port of the plurality of ports transmitting a packet and a second path corresponding to providing ToDs for the port of the plurality of ports receiving a packet.

EXAMPLE EMBODIMENT 7. The integrated circuit device of example embodiment 6, wherein the first path comprises a transmitter ToD synchronizer to synchronize the ToD to a ToD circuit of a specified PTP clock domain and subordinate ToD circuitry to provide the ToD to an Ethernet MAC of a port of the plurality of ports.

EXAMPLE EMBODIMENT 8. The integrated circuit device of example embodiment 6, wherein the second path comprises receiver ToD synchronizer to synchronize the ToD to a ToD circuit of a specified PTP clock domain and subordinate ToD circuitry to receive the TOD of an Ethernet MAC of a port of the plurality of ports.

EXAMPLE EMBODIMENT 9. The integrated circuit device of example embodiment 1, wherein the timestamp engine comprises a clock selection multiplexer configurable to select from among a plurality of clocks associated with the different ToD circuits.

EXAMPLE EMBODIMENT 10. The integrated circuit device of example embodiment 1, wherein the timestamp engine is configurable to provide different SyncE signals to the different ports of the plurality of ports based on the different ToDs associated with the plurality of PTP clock domains.

EXAMPLE EMBODIMENT 11. The integrated circuit device of example embodiment 1, wherein the integrated circuit device comprises a programmable logic device.

EXAMPLE EMBODIMENT 12. A method comprising:
in a network switch comprising a plurality of master time of day (ToD) subsystems, connecting a ToD circuit of a first master ToD subsystem of the plurality of master ToD subsystems to any selected downstream port that is unused from among all downstream ports of the network switch; and
in the network switch, enabling the selected downstream port to send timestamp requests and receive ToDs based on the master ToD circuit of the first master ToD subsystem.

EXAMPLE EMBODIMENT 13. The method of example embodiment 12, comprising, in the network switch, partially reconfiguring a programmable logic device of the network switch to create the first master ToD subsystem.

EXAMPLE EMBODIMENT 14. The method of example embodiment 12, comprising, in the network switch, routing read requests on the selected downstream port to the master ToD circuit of the first master ToD subsystem.

EXAMPLE EMBODIMENT 15. The method of example embodiment 12, comprising, in the network switch, causing a timestamp engine to provide timestamps to PTP extraction circuitry of the selected downstream port based on the master ToD circuit of the first master ToD subsystem.

EXAMPLE EMBODIMENT 16. A system comprising:
a programmable logic device comprising a plurality of network ports and a timestamp engine configurable to support a plurality of Precision Time Protocol (PTP) clock domains; and
a host data processing system to configure the timestamp engine.

EXAMPLE EMBODIMENT 17. The system of example embodiment 16, wherein the timestamp engine is configurable to supply a first time of day (ToD) to a first port of the plurality of network ports based on a first PTP clock domain of the plurality of PTP clock domains and supply a second ToD to a second port of the plurality of network ports based on a second PTP clock domain of the plurality of PTP clock domains.

EXAMPLE EMBODIMENT 18. The system of example embodiment 16, wherein the timestamp engine is configurable to supply a first clock signal to a first port of the plurality of network ports based on a first PTP clock domain of the plurality of PTP clock domains and supply a second clock signal to a second port of the plurality of network ports based on a second PTP clock domain of the plurality of PTP clock domains.

EXAMPLE EMBODIMENT 19. The system of example embodiment 16, wherein the host data processing system is to condition a ToD circuit of a master ToD subsystem to a PTP clock domain of the plurality of PTP clock domains.

EXAMPLE EMBODIMENT 20. The system of example embodiment 16, wherein the programmable logic device comprises a field programmable gate array (FPGA) device.

What is claimed is:

1. An integrated circuit device comprising:
a plurality of ports configurable to communicate using timestamps corresponding to a plurality of Precision Time Protocol (PTP) clock domains; and
a timestamp engine configurable to receive timestamp requests and route a time of day (ToD) from a ToD circuit of a plurality of ToD circuits to different ports of the plurality of ports, wherein each ToD circuit is based on a PTP clock domain of the plurality of PTP clock domains.

2. The integrated circuit device of claim 1, wherein the plurality of ports comprises a plurality of Ethernet ports.

3. The integrated circuit device of claim 1, wherein the timestamp engine comprises a ToD selector configurable to select from among the different ToD circuits associated with the plurality of PTP clock domains.

4. The integrated circuit device of claim 3, wherein the ToD selector is configurable to select a first ToD circuit from among the different ToD circuits to provide a ToD to a downstream port of the plurality of ports, wherein the different ToDs circuits are accessible via an industry-defined interface.

5. The integrated circuit device of claim 4, wherein the industry-defined interface comprises an Advanced extensible Interface (AXI) interface.

6. The integrated circuit device of claim 1, wherein the timestamp engine comprises a first path corresponding to providing ToDs for a port of the plurality of ports transmitting a packet and a second path corresponding to providing ToDs for the port of the plurality of ports receiving a packet.

7. The integrated circuit device of claim 6, wherein the first path comprises a transmitter ToD synchronizer to synchronize the ToD to a ToD circuit of a specified PTP clock domain and subordinate ToD circuitry to provide the ToD to an Ethernet MAC of a port of the plurality of ports.

8. The integrated circuit device of claim 6, wherein the second path comprises receiver ToD synchronizer to synchronize the ToD to a ToD circuit of a specified PTP clock domain and subordinate ToD circuitry to receive the TOD of an Ethernet MAC of a port of the plurality of ports.

9. The integrated circuit device of claim 1, wherein the timestamp engine comprises a clock selection multiplexer configurable to select from among a plurality of clocks associated with the different ToD circuits.

10. The integrated circuit device of claim 1, wherein the timestamp engine is configurable to provide different SyncE signals to the different ports of the plurality of ports based on the different ToDs associated with the plurality of PTP clock domains.

11. The integrated circuit device of claim 1, wherein the integrated circuit device comprises a programmable logic device.

12. A method comprising:
in a network switch comprising a plurality of master time of day (ToD) subsystems, connecting a ToD circuit of a first master ToD subsystem of the plurality of master ToD subsystems to any selected downstream port that is unused from among all downstream ports of the network switch; and
in the network switch, enabling the selected downstream port to send timestamp requests and receive ToDs based on the master ToD circuit of the first master ToD subsystem.

13. The method of claim 12, comprising, in the network switch, partially reconfiguring a programmable logic device of the network switch to create the first master ToD subsystem.

14. The method of claim 12, comprising, in the network switch, routing read requests on the selected downstream port to the master ToD circuit of the first master ToD subsystem.

15. The method of claim 12, comprising, in the network switch, causing a timestamp engine to provide timestamps to PTP extraction circuitry of the selected downstream port based on the master ToD circuit of the first master ToD subsystem.

16. A system comprising:
a programmable logic device comprising a plurality of network ports and a timestamp engine configurable to support a plurality of Precision Time Protocol (PTP) clock domains; and
a host data processing system to configure the timestamp engine.

17. The system of claim 16, wherein the timestamp engine is configurable to supply a first time of day (ToD) to a first port of the plurality of network ports based on a first PTP clock domain of the plurality of PTP clock domains and supply a second ToD to a second port of the plurality of network ports based on a second PTP clock domain of the plurality of PTP clock domains.

18. The system of claim 16, wherein the timestamp engine is configurable to supply a first clock signal to a first port of the plurality of network ports based on a first PTP clock domain of the plurality of PTP clock domains and supply a second clock signal to a second port of the plurality of network ports based on a second PTP clock domain of the plurality of PTP clock domains.

19. The system of claim 16, wherein the host data processing system is to condition a ToD circuit of a master ToD subsystem to a PTP clock domain of the plurality of PTP clock domains.

20. The system of claim 16, wherein the programmable logic device comprises a field programmable gate array (FPGA) device.
